(19) United States
(12) Patent Application Publication
(10) Pub. No.: US 2004/0023142 A1
(43) Pub. Date: Feb. 5, 2004

(54) Universal carrier, method for the production thereof and a two-component developer for an electrophotographic printing system

(76) Inventors: Jean-Phillippe Hulin, Munich (DE); Andreas Paul, Vaterstetten (DE); Manfred Muenz, Erding (DE); Martin Schleusener, Newfarm (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/362,190

(22) PCT Filed: Aug. 23, 2001
(86) PCT No.: PCT/EP01/09758

(30) Foreign Application Priority Data
Aug. 24, 2000 (DE) 100 41 621. 7

(51) Int. Cl. G03G 9/10

(52) U.S. Cl. 430/111.1; 430/137.1

(57) ABSTRACT

The present invention relates to a universal carrier for a two-component developer comprising a carrier base component and a carrier preaging component that comprises at least one toner resin and/or at least one surface additive, the carrier base component being present in the form of at least partially abraded particles and part of the carrier preaging component adhering to the outside surfaces of the particles of the carrier base component and part of the carrier preaging component being contained in surface depressions of the particles of the carrier base component. Compositions comprising the inventive universal carrier and usual toners yield a two-component developer that requires no toner-specific preaging but can be used directly in the printer.

This invention relates to universal carriers for two-component developers comprising a carrier base component and a carrier preaging component, a method for its production wherein the carrier base component is coated with the carrier preaging component, and two-component developers based on the universal carrier. The two-component developers are employable in electrophotographic printing processes directly, that is, without a preaging process.

Two-component development is one of the most frequently applied development methods in electrophotographic printing. In the two-component developers required therefor, the magnetic carrier material, the carrier, is not consumed but serves to charge the toner by friction, among other things.

Two-component developers for electrophotographic printing systems contain a carrier and a toner. The toner in turn consists of colorants and toner resin as a binder. Furthermore, it can contain different additives, such as charge control agents (CCA), waxes, magnetic powders and surface additives such as silica, diverse polymers and so-called scum preventers. The toner may be a uniform toner or a mixture of different toners that, in interaction with the carrier used, behave physically like a uniform toner (color mix toner).

The carrier is frequently subjected to pretreatment. Such pretreatment can consist for example of oxidizing or nitrating the surface to change the triboelectric properties or to reduce electric conductivity and moisture sensitivity. A similar effect is achieved by coatings with polymers. Furthermore, coating with polymers increases the long-term stability of the carrier and improves pourability.

EP-0 412 352 A1 describes a method for preaging the carrier. The carrier is mixed with a mixture of toner and charge control agent. The carrier is then separated. U.S. Pat. No. 3,970,571 discloses a method for pretreating the carrier with a small quantity of toner that has a higher concentration of charge control agent than the later toner.

If pure carrier is mixed with toner, a distinct “break-in behavior” appears during printing: the mixture does not show a stable printed image at the beginning since the physical properties of the mixture change. In this break-in process, toner is “smeared” on the surface of the carrier and deposited in depressions on the surface of the carrier. Furthermore, the carrier is somewhat abraded, i.e. leveled off, on the surface. Only after this break-in process can printing be done with uniformly good quality.

This break-in process can be avoided or at least shortened by “preaging” (artificially aging or preconditioning) the developers. In this preaging, carrier and toner are jointly subjected to an intensive intermixing process in special equipment whereby the break-in otherwise taking place in the printer is performed quasi in quick motion. If developer of a certain composition is required, a preaging process must thus be performed with the corresponding toner for the required quantity of developer.

Frequently, one and the same carrier is used in conjunction with different toners for different cases of application (print resolution, colors). The conventional procedure is disadvantageous in that a preaging process must be performed separately for each developer, with the specific toner that is used in the developer. The preaged developer must be separately packed and stored, which involves procedural and organizational effort. The disadvantage of the required preaging process is especially serious when only small quantities of a certain developer are required. For example, many firms select a special color tone for their logos, and the corresponding customized color toners and developers are then required for printing these logos. In case of repeat orders, small quantities of developer must then be newly mixed and subjected to the preaging treatment, which is elaborate and expensive.

To avoid these disadvantages it would be desirable to have a universal carrier that makes toner-specific preaging unnecessary, that is, a universal carrier that can be combined with a desired toner directly into a ready-to-use developer.

The problem of the present invention is therefore to provide such a universal carrier and a method for its production.

The problem of the present invention is furthermore to provide a two-component developer that requires no preaging but can be produced by simply combining carrier and toner and is ready to use without jointly preaging carrier and toner.

The problem is solved by the inventive universal carrier for two-component developers comprising:

a carrier base component, and

a carrier preaging component containing at least one toner constituent, and optionally several toner constituents,

wherein

the carrier base component is present in the form of at least partially abraded particles and/or

part of the carrier preaging component adheres to the outside surfaces of the particles of the carrier base component and/or part of the carrier preaging component is contained in surface depressions of the particles of the carrier base component,

the at least one toner constituent is a toner resin and/or at least one surface additive, and

if the optionally several toner constituents have a colorant, the colorant is present in a coloring quantity not disturbing for a printing process.

The problem is furthermore solved by the inventive method for producing a universal carrier for two-component developers comprising:

providing a carrier base component and a carrier preaging component that contains at least one toner constituent, and optionally several toner constituents, the at least one toner constituent being a toner resin and/or at least one surface additive,

intimately contacting and intermixing the carrier base component with the carrier preaging component with such intensity that part of the carrier preaging component penetrates into depressions on the surface of particles of the carrier base component and/or part of the carrier preaging component adheres to the outside surfaces of particles of the carrier base component, and/or the particles of the carrier base component are at least partly abraded, and

if the optionally several toner constituents have a colorant, removing colorant not bound to the carrier base component in print-proof fashion, at least up to an insufficient quantity for a printing process.

The problem is furthermore solved by the inventive two-component developer for electrophotographic printing systems that contains an inventive universal carrier and a conventional toner.

The problem is furthermore solved by the inventive method for producing a two-component developer wherein the inventive universal carrier and a conventional toner are combined and optionally slightly mixed.

As mentioned above, the conventional preaging process is performed with the complete developer composition. Preaging fully or at least largely anticipates the processes otherwise occurring during “break-in” in the printer. Furthermore, it is known that developer compositions react very sensitively to changes of a component. The change of only one component can have drastic effects on the printing behavior.

The components of a developer are not additive, they are in interaction with each other. The properties of a developer, in particular its triboelectric properties, electric charging and transport of the toner, and the ability to cleanly transfer toner, depend on the components being carefully coordinated with each other and the developer being preaged in suitable fashion.

Therefore, it is obvious and readily understandable to view the developer as a complex unit that is inseparable in each stage, as has hitherto actually been the case. It has generally been assumed that this inseparable unit is an essential property of developers also and particularly at the preaging stage, in which carrier and toner components combine into a perfectly functioning mixture meeting the requirements for printing quality.

However, it has surprisingly been found that it is not necessary to perform the preaging process of a two-component developer with the complete developer composition of carrier and toner (developer toner). Rather, a comparable result can be achieved if one or more of the developer toner components are omitted in the preaging process, or if another toner (preaging toner), optionally with a certain similarity to the developer toner, or constituents of this other toner (preaging toner) are used for preaging.

It may be sufficient if preaging is performed with the binder resin and/or at least one surface additive. The carrier preaging component is applied to the carrier in a quantity of a few weight percent of the total composition. It can contain, besides toner resin and surface additives, further usual toner constituents. The precise quantity of preaging component to be applied is dependent on its composition. If it consists only of surface additives, 0.01 to 1 wt % of the total composition, preferably 0.05 to 0.5 wt %, is sufficient. If it consists of the binder resin, optionally with further usual toner constituents, larger quantities are more favorable, preferably 0.1 to 7 wt %, especially preferably 0.5 to 5 wt %, of the total composition of carrier plus preaging component.

Alternatively, preaging can also be performed with a wax.

It is essential to the invention that the preaging process of carrier base component and carrier preaging component guarantees intensive surface interaction of the components. The inventive preaging is preferably performed in comparable or identical fashion to usual toner-specific preaging. Carrier base component and carrier preaging component are thus contacted in suitable mixing apparatuses for a sufficient time, typically about 1 minute to 1 hour, normally about 20 minutes. The carrier particles are thereby changed in similar fashion as in toner-specific preaging, that is, part of the carrier preaging component penetrates into depressions on the surface of particles of the carrier base component and/or part of the carrier preaging component adheres to the outside surface of particles of the carrier base component. Typically, both happen simultaneously. Furthermore, the particles of the carrier base component are abraded (leveled off) to a greater or lesser degree on the surface.

If a conventional toner is added to a thus pretreated carrier, virtually no break-in behavior is to be detected, and the developer mixture immediately shows stable printing behavior.

As mentioned, it is not necessary to perform preaging with a complete toner. However, usual toner constituents can also be used in usual quantity ratios and particle sizes.

The inventive carrier preaging component contains a toner resin, i.e. a binder resin, and/or one or more surface additives, preferably toner resin and surface additives or only toner resin.

The toner resin can fundamentally be any binder resin as is used in commercial toners. Toner resin mixtures can also be used with advantage. Well-suited toner resins are polyesters, epoxy resins, acrylic resins, polyamides, polyethylene, polystyrene, styrene-acrylate copolymers, butadiene-styrene and mixtures thereof.

Surface additives to be used are additives that improve e.g. pourability, triboelectric properties or film-forming propensity. Examples of surface additives are silica, e.g. colloidal silica such as Aerosil (Nippon Aerosil Co., Ltd.) or HDK (Wacker-Chemie GmbH), metal oxides such as titanium oxide, aluminum or cerium oxide, metal salts of fatty acids such as zinc stearate, silicon carbide such as HSC 059/200 (Superior Graphite Co.), diverse polymers, so-called scum preventers and charge control agents.

Additionally, further internal additives, i.e. additives dispersed within the toner resin, can be contained. These include e.g. waxes as separating agents and for improving fixing behavior.

Waxes with low molecular weight such as polyolefins are preferred. Among the polyolefins available on the market, polyethylene and polypropylene are preferred as are commercially available e.g. under the trade names Viscol (Sanyo Chemical Industries) or Epolene (Eastman Chemical Products Inc.). Waxes are preferably used in a quantity of 1 to 10 wt % based on carrier preaging component.

Some toners, such as MICR toners used for example for printing magnetically readable characters, contain magnetizable powders. These too can be dispersed in the carrier preaging component as internal additives.

Additionally, charge control agents can be used as internal additives.

The selection of charge control agents depends initially on whether the toner is to be positively or negatively chargeable electrically. Suitable charge control agents and positively chargeable and negatively chargeable toners are available on the market. Examples of positively chargeable toners are quaternary ammonium salt compounds such as “TP-415” (Hodogaya Chemical Co., Ltd.), “Bontron P-51” (Orient Chemical Co., Ltd.), polyamine resins such as “AFP-B” (Orient Chemical Co., Ltd.) and polymers functionalized with quaternary ammonium salts such as “FCA-201-PF” (Fujikura Kasei Co., Ltd.).

Examples of negatively chargeable toners are potassium borobisbenzylate such as “LR-147” (Japan Carlit Co., Ltd.), metal complexes of alkyl derivatives of salicylic acid such as “Bontron E-81” and “Bontron E-84” (Orient Chemical Co., Ltd.), polymers functionalized with sulfonic acid such as “FCA-1001-NS” (Fujikura Kasei Co., Ltd.) and quaternary ammonium salt compounds such as “Copy Charge NXVP434” (Clariant GmbH).

These charge control agents are preferably used in toner in a quantity of about 0.1 to 5 wt %, preferably about 0.5 to 2 wt %, based on the particular toner. The corresponding quantities are also suitable for the carrier preaging component.

Suitable carrier base components for the inventive universal carrier are fundamentally the usual carriers for two-component developers. Examples are carrier powders of quartz sand, glass, steel, aluminum, iron, ferrites, magnetites and composite powders of polymer/magnetic pigment. Preferred carrier materials are irregularly formed powdered iron, magnetites and ferrites, e.g. lithium ferrite, MgMn ferrite, Mn ferrite, Sr ferrite. The mean particle size is typically 10 to 200 microns.

Preferred carriers have a specific resistance of 10⁷ to 10¹² Ωcm.

If the carrier preaging component contains a toner resin, the mean particle diameter is preferably between 3 microns and 20 microns.

The proportion of carrier preaging component in the universal carrier is preferably 0.1 to 7 wt %, depending on which toner constituent or toner constituents the preaging component consists of.

The carrier preaging component is preferably free from colorants. It is especially preferable for the toner used for pretreatment to be a complete, colorant-free, i.e. transparent, toner.

However, the carrier preaging component can also contain colorants of any color, as do usual toners. Suitable colorants are for example also UV- and IR-active, for example fluorescent, colorants, metallic particles or particles with a metallic effect, as are available e.g. under the trade name Iriodine (Merck GmbH).

Usual toners preferably contain the colorant in a quantity of 1 to 25 wt % based on the total weight of the toner. The carrier preaging component is preferably free from colorants, and if colorants are nevertheless contained, the colorants not bound in print-proof fashion must be largely removed after termination of the preaging process of the carrier base component with the carrier preaging component, optionally together with other surplus constituents, for example by blowing off.

Pretreatment of the carrier with a preaging component containing colorant is possible because a certain part of the carrier preaging component is bound to the carrier base component in print-proof fashion, that is, it is bound so firmly that it cannot be removed during the printing operation. Thus, print-proof bound colorants of a color other than the printing ink do not disturb printing. Colorants that are not print-proof bound must not reach or exceed the quantity that would disturb a printing process.

The quantities of the other constituents of the carrier preaging component are uncritical. They can be present in the finished universal carrier solely in print-proof bound form or in print-proof bound and free form. Therefore, the upper quantity limit for these constituents is in the range of the upper quantity limits of the particular constituents in a finished developer.

The inventive universal carrier thus differs, even when pretreated with a complete conventional toner, from a conventional developer comprising carrier and toner, namely in that it does not contain any colorant or only print-proof bound colorant or print-proof bound colorant and additionally not print-proof bound colorant in a quantity insufficient or at least not disturbing for a printing process. Preferably, the inventive universal carrier also contains the other constituents of the carrier preaging component in a smaller quantity than the particular constituents are contained in a developer. It is especially preferable for substantially all constituents of the carrier preaging component to be bound to the carrier in print-proof fashion.

The present invention thus makes it possible to pretreat a common carrier with practically any toner as a carrier preaging component, and to produce from the carrier together with the same or another toner a developer that is immediately ready to use without any preaging treatment.

It is usual to subject carriers, before mixture with a toner, additionally to a separate pretreatment known as coating. Coating serves substantially to adjust the tribo level, obtain long-term stability, adapt resistance and guarantee sufficient pourability. For coating, polymers are frequently used.

These polymers differ fundamentally from the toner resin. They are wear-resistant, high-melting products with anti-adhesive properties that must seal the carrier and simultaneously permit easy detachment of the toner during printing and fast and stable charging of the toner. Typical coating polymers are acrylic-styrene copolymers, silicones and fluorocarbons such as teflon. In contrast, toner resins must have good miscibility with the other toner constituents and bond with them and the paper to be printed at the fixation temperatures, i.e. about 100 to 200° C. They therefore have a relatively low melting point and good adhesive properties.

It is likewise possible according to the invention to incorporate the coating of the carrier base component with the carrier preaging component into the coating process, that is, perform the preaging directly instead of coating.

The inventive universal carrier yields with a conventional toner a two-component developer that is very well suited for electrophotographic printing systems. Somewhat less toner is added to the universal carrier than is customarily used for such developers. About 2 to 12 wt %, preferably about 5 wt %, of toner is added to a carrier not inventively pretreated, so that the two-component developer consists of about 88 to 98 wt %, preferably about 95 wt %, of carrier and about 2 to 12 wt %, preferably about 5 wt %, of toner. However, the inventively pretreated universal carrier already contains a preaging component, so that the newly added quantity of toner can be reduced accordingly, preferably by 0.1 to 7 wt %, especially preferably by 0.5 to 2 wt %.

Especially preferred toners are ones based on polyester as toner resin, in particular toners with an acid value of 0.1 to 30 mg KOH/g. The toner resin preferably has an acid value of 0.1 to 45 mg KOH/g since these toners have especially good miscibility with other toners.

Fundamentally, any common toner can be used together with the inventive universal carrier. Especially good results are obtained, however, if carrier preaging component and toner are chemically similar and have similar physical properties. In the case of preaging by means of toner resin, it is in particular favorable if the toner resin used is similar or, especially preferably, identical in carrier preaging component and toner.

The surface additives, if contained in the carrier preaging component, are also preferably chemically similar in carrier preaging component and toner. Charge control agents must of course produce like electric charges.

The inventive two-component developer can contain the universal carrier and the toner in mixed form, i.e. toner and universal carrier can be mixed externally, i.e. outside the printer, but universal carrier and toner can also be present separately from each other. The universal carrier can then be used in the printer unmixed. The toner is in this case added in the printer. No intensive mixing is required for producing the two-component developer.

The inventive universal carrier is thus an actually universally employable carrier that can be used for example for different color toners, in particular color toners produced in small quantities specifically for customer applications, also metallic, metallic-effect and UV- or IR-active toners, toners for security applications, different black toners in different grain sizes and for MICR toners for document readers.

The inventive carrier pretreatment with one component or several components of usual toners offers in particular the following advantages.

It is possible to provide developers for customized color toners ad hoc without keeping the particular developer on stock. In case of repeat orders of developer for customized color toners, no new production of small quantities is required.

No special apparatus is required for individual preaging of developers.

The developer primary product can be produced cost-effectively and centrally in large quantities.

The development effort for developers as well as logistic effort and overhead are considerably reduced.

There is no need for elaborate production, decanting or cleaning operations.

1. A universal carrier for two-component developers comprising:
a carrier base component, and
a carrier preaging component containing at least one toner constituent, and optionally several toner constituents,
wherein
the carrier base component is present in the form of at least partially abraded particles and/or
part of the carrier preaging component adheres to the outside surfaces of the particles of the carrier base component and/or part of the carrier preaging component is contained in surface depressions of the particles of the carrier base component,
the at least one toner constituent is a toner resin and/or at least one surface additive, and
if the optionally several toner constituents have a colorant, the colorant is present in a coloring quantity not disturbing for a printing process.

2. A universal carrier according to claim 1, characterized in that the carrier preaging component is free from colorants.

3. A universal carrier according to claim 1 or 2, characterized in that the carrier preaging component is a complete, colorant-free toner.

4. A universal carrier according to claim 1, characterized in that the optionally present colorant is present substantially solely in a form bound to the carrier base component in print-proof fashion.

5. A universal carrier according to any of claims 1 to 3, characterized in that the carrier preaging component is partially bound to the carrier base component in print-proof fashion and is partially present in free form.

6. A universal carrier according to any of claims 1 to 5, characterized in that the carrier preaging component is 0.1 to 7 wt %.

7. A universal carrier according to any of claims 1 to 6, characterized in that the acid value of the carrier preaging component is 0.1 to 30 mg KOH/g.

8. A universal carrier according to any of claims 1 to 7, characterized in that the toner resin is a polyester, preferably with an acid value of 0.1 to 45 mg KOH/g.

9. A universal carrier according to any of claims 1 to 6, characterized in that the acid value of the carrier preaging component is 0.1 to 30 mg KOH/g and the toner resin is a polyester, preferably with an acid value of 0.1 to 45 mg KOH/g.

10. A universal carrier according to any of claims 1 to 6, characterized in that the carrier preaging component is a complete, preferably colorant-free, toner and the acid value of the carrier preaging component is 0.1 to 30 mg KOH/g and the toner resin is a polyester, preferably with an acid value of 0.1 to 45 mg KOH/g.

11. A universal carrier according to any of claims 1 to 10, characterized in that the carrier base component has no coating.

12. A method for producing a universal carrier for two-component developers comprising:
providing a carrier base component and a carrier preaging component that contains at least one toner constituent, and optionally several toner constituents, the at least one toner constituent being a toner resin and/or at least one surface additive,
intimately contacting and intermixing the carrier base component with the carrier preaging component with such intensity that part of the carrier preaging component penetrates into depressions on the surface of particles of the carrier base component and/or part of the carrier preaging component adheres to the outside surfaces of particles of the carrier base component, and/or the particles of the carrier base component are at least partly abraded, and
removing at most part of the toner constituent (or constituents) in such a way that toner constituents bound to the carrier base component in print-proof fashion or present in free form remain in the universal carrier,
whereby, if a colorant is contained, colorant not bound to the carrier base component in print-proof fashion is removed at least up to a coloring quantity not disturbing for a printing process.

13. A method according to claim 12, characterized in that a complete colorant-free toner is used as the carrier preaging component.

14. A method according to claim 12, characterized in that a complete colorant-containing toner is used as the carrier preaging component, and colorants and optionally further toner constituents that are not bound to the carrier in print-proof fashion are removed.

15. A method according to any of claims 12 to 14, characterized in that the carrier preaging component is used in a quantity of 0.1 to 7 wt %.

16. A two-component developer for electrophotographic printing systems comprising a universal carrier according to any of claims 1 to 11 and a toner.

17. A two-component developer according to claim 16, characterized in that the toner is 2 to 12 wt % of the developer.

18. A two-component developer according to claim 16 or 17, characterized in that the toner contains the same type of toner resin and/or the same type of charge control agent, preferably identical toner resin and/or identical charge control agent, as the carrier preaging component.

19. Use of toner resin and/or surface additives in the production of a universal carrier according to any of claims 1 to 11.

20. A method for producing a two-component developer according to any of claims 16 to 18, characterized in that a universal carrier according to any of claims 1 to 11 and a toner are combined.

21. An electrophotographic printing process, characterized in that the toner is added to the carrier only in the printer whereby a universal carrier according to any of claims 1 to 11 is used.
